(19) United States
(12) Patent Application Publication
(10) Pub. No.: US 2002/0080197 A1
(43) Pub. Date: Jun. 27, 2002

(54) Method of providing a display for a graphical user interface

(75) Inventor: Judith F.M. Masthoff, Brighton (GB)

Correspondence Address: U.S. Philips Corporation, Corporate Patent Counsel, 580 White Plains Road, Tarrytown, NY, 10591, US

(73) Assignee: KONINKLIJKE PHILIPS ELECTRONICS N.V.

(21) Appl. No.: 10/023,085

(22) Filed: Dec. 17, 2001

(30) Foreign Application Priority Data
Dec. 27, 2000 (GB) 0031617.4

(51) Int. Cl. G09G 5/00

(52) U.S. Cl. 345/862

(57) ABSTRACT

A method of providing a display (11) for a graphical user interface in which a user may define a selected point (13) of a subject image (12) is disclosed together with a computer program, a computer-readable storage medium (62) and apparatus for the same (61). The method comprising the steps of (i) displaying the subject image (12); (ii) displaying an enlargement of the subject image (12′) in response to a user selecting a point (21) on the subject image and displaying on that enlargement that point selected by the user; and (iii) returning a point (40) previously selected by the user as displayed on an enlargement (12″) of the subject image as a first co-ordinate parameter. Additionally, the method may further comprise the step of (iv) displaying a reduction of a previous enlargement of the subject image, wherein steps (iii) and (iv) are done in response to a single user input.

This invention relates to a method of providing a display for a graphical user interface (GUI) and to a computer program, a computer-readable storage medium and apparatus for the same. In particular, the invention relates to providing a display for a GUI in which an enlargement of a subject image is displayed in response to a user selecting a point on that subject image.

Using a computer, a display and a user input device, it is known to display an image such as a map wherein a user selecting a point on that image causes an enlargement of that image to be displayed, centered about that point selected by the user. It is further known to repeat this process whereby the user selecting a point on a previous enlargement causes a further enlargement to be displayed.

The user input device may be a touch sensitive display and where this is the case, a point may be selected by a user touching the display. However, the “foot print” of a user's finger is often so big in relation to the image as to cause ambiguity in the point selected by the user. That is, the point intended to be selected by the user is not the precise point identified by the computer. For merely viewing an image using the efficient enlargement technique described above, this ambiguity would typically not be significant. However, where a point is being selected for identifying a specific position on an image, for example, to select one of two points A and B on the image to provide a distance calculation between points A and B, this ambiguity can be significant. Furthermore, the significance of such ambiguity varies depending on the requirements of the user.

It is an object of the present invention to provide a method of providing a display for a graphical user interface in which a user may accurately define a selected point on a subject image quickly and efficiently.

According to the present invention, such a method is provided comprising the steps of (i) displaying the subject image; (ii) displaying an enlargement of the subject image in response to a user selecting a point on the subject image and displaying on that enlargement that point selected by the user; and (iii) returning a point previously selected by the user as displayed on an enlargement of the subject image as a first co-ordinate parameter.

Such a method provides a quick and efficient method of selecting a point on a map and returning that point as a co-ordinate parameter selected by a user. In particular, by displaying a previously selected point on an enlarged display, the user can use this to base a decision on whether the selected point is of the required accuracy or whether reselection is required.

To further increase the speed of selection by providing the additional step of (iv) displaying a reduction of a previous enlargement of the subject image where steps (iii) and (iv) are done in response to a single user input. Thus, on confirmation of the selected point where that point is returned as a first co-ordinate parameter, the scale of the subject image is reduced simultaneously.

On confirmation of the selected point by the user, a reduction of a previous enlargement of the subject image is displayed which may be in the same scale as the original subject image, thereby reducing the number of steps carried out by the user.

In order to enable accurate point selection, the method may further comprise the step of displaying a further enlargement of a previous enlargement of the subject image in response to a user selecting a point on that previous enlargement, preferably displayed centered about that point selected by the user.

The method may further comprise the step of returning a further point selected by the user as a second co-ordinate parameter which may be useful, for example, should a subsequent calculation be performed to determine the distance between first and second co-ordinate parameters.

Embodiments of the present invention will now be described, by way of example only, with reference to the accompanying figures in which:

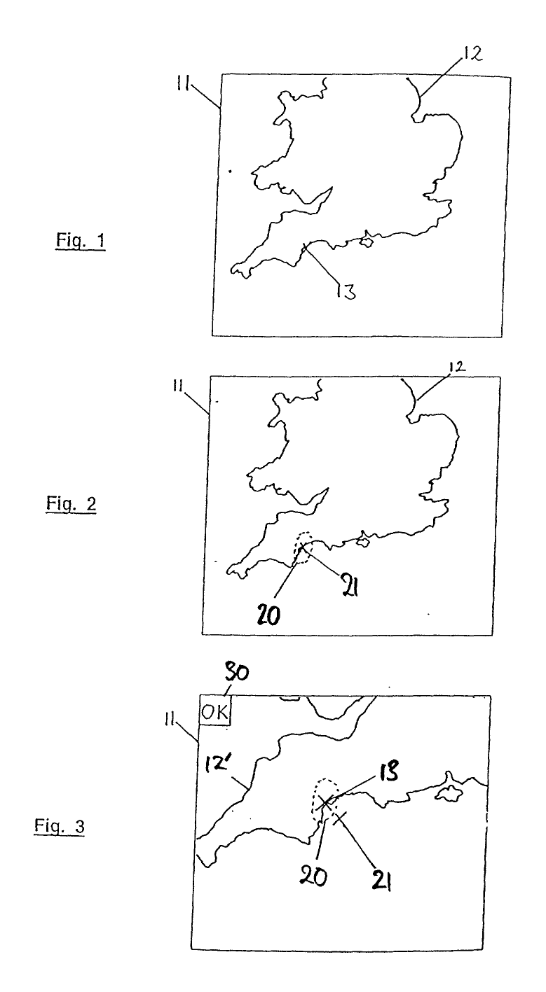

FIGS. 1 to 5 illustrate methods for providing a display according to the present invention; and

FIG. 6 shows, schematically, a computer system capable of implementing the methods illustrated in FIGS. 1 to 5.

Referring to FIG. 1, a touch sensitive display 11 of conventional type is shown, controlled by a computer (not shown) in a manner according to the present invention. In this example, a image of a geographical map 12 of the southern part of the United Kingdom is displayed on the display and we shall assume that a user wishes to select the location of a particular coastal town 13 on that map. A user does so by touching the touch sensitive display 11 at the required location and in doing so makes a footprint 20 shown in FIG. 2, the foot print being the area of contact between the finger of the user and the display. A selected point 21 may be defined as the centroid of the footprint.

As illustrated in FIG. 3 and in accordance with the present invention, a user selecting a point on the display 11 causes the map 12 to be enlarged, centered about the selected point 21. From FIG. 3 which shows that enlargement including the selected point which is also displayed, the inaccuracy of the users selection is evident and is caused primarily by the large size of the footprint in relation to the scale of the map as shown in FIGS. 1 and 2. In this example, the point identified as selected by the user which is intended to be a coastal town is in fact located out to sea.

Further in accordance with the present invention and as a result of the user selecting a point on the display is the appearance of an “OK” button 30. In the event the selection of the point 21 is considered by the user to be of sufficient accuracy in light of viewing the enlargement, the “OK” button may be touched resulting in the selected point being returned as a co-ordinate parameter which can be used in a subsequent calculation.

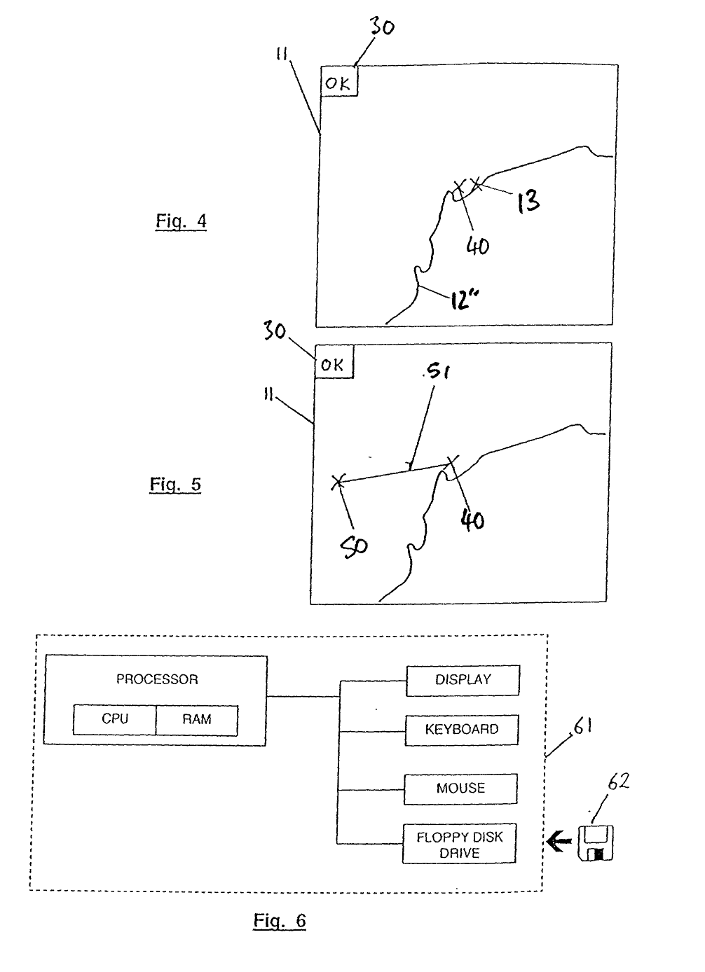

In the event that a user considers that the selected point is not sufficiently accurate and elects to select a further point on the enlargement of FIG. 3, a further enlargement is displayed, as shown in FIG. 4, including that point 40 further selected by the user.

Then, in the event that the user considers that further selected point selected to be sufficiently accurate, the user may confirm their selection by touching the “OK” button. This causes the further selected point 40 being returned as a co-ordinate parameter and the display to return to its initial scale (as shown in FIGS. 1 and 2).

FIG. 5 illustrates the scenario where an additional point 50 is selected to supplement selected point 40 and a function executed to determined the distance between the two points. In a map context, the distance may not necessarily be a straight line but may take into account permissible travel routes.

A computer system 61 capable of implementing the above method is shown schematically in FIG. 6. The computer system comprises a processor having a central processing unit (CPU) and a random access memory (RAM). The computer system further comprises a display, keyboard, mouse and a floppy disk drive, all coupled to the processor in known manner. A floppy disk 62 is provided for the floppy disk drive having recorded thereon a computer program comprising instructions for performing a method according to the present invention. Alternatively, other types of computer-readable storage media and corresponding hardware may be used.

Implementation of a method according to the present invention in such a computer system may be readily accomplished in hardware, in software by appropriate computer programming and configuration or through a combination of both. Of course, such programming and configuration is well known and would be accomplished by one of ordinary skill in the art without undue burden. It would be further understood by one of ordinary skill in the art that the teaching of the present invention applies equally to other types of apparatus having a GUI and not only to the aforementioned computer system.

1. A method of providing a display for a graphical user interface in which a user may define a selected point on a subject image, the method comprising the steps of:
(i) displaying the subject image;
(ii) displaying an enlargement of the subject image in response to a user selecting a point on the subject image and displaying on that enlargement that point selected by the user; and
(iii) returning a point previously selected by the user as displayed on an enlargement of the subject image as a first co-ordinate parameter.

2. A method according to claim 1 further comprising the step of (iv) displaying a reduction of a previous enlargement of the subject image, wherein steps (iii) and (iv) are done in response to a single user input.

3. A method according to claim 1 further comprising the step of displaying a further enlargement of a previous enlargement of the subject image in response to a user selecting a point on that previous enlargement.

4. A method according to claim 1 wherein an enlargement of the subject image displayed in response to a user selecting a point on that subject image is displayed centered about that point selected by the user.

5. A method according to claim 1 wherein a reduction of a previous enlargement of the subject image is displayed in the same scale as the subject image prior to enlargement.

6. A method according to claim 1 further comprising the step of returning a further point selected by the user as a second co-ordinate parameter.

7. A method according to claim 6 further comprising the step of performing a calculation to determine the distance between the first and second co-ordinate parameters.

8. A computer program comprising instructions for performing a method according to claim 1.

9. A computer-readable storage medium having recorded thereon data representing instructions for performing a method according to claim 1.

10. Apparatus having a display, a processor and a user input device wherein the processor is programmed to perform a method according to claim 1.
